(19) United States
(12) Patent Application Publication
(10) Pub. No.: US 2015/0256846 A1
(43) Pub. Date: Sep. 10, 2015

(54) IMAGE PROCESSING APPARATUS, IMAGE PROCESSING METHOD AND IMAGE PROCESSING SYSTEM

(71) Applicant: Sony Corporation, Tokyo (JP)

(72) Inventors: Shinobu HATTORI, Tokyo (JP); Hirofumi KASAI, Kanagawa (JP); Kenichi KANAI, Tokyo (JP); Takumi TSURU, Chiba (JP); Toshiya HAMADA, Saitama (JP); Hiroaki ETO, Kanagawa (JP)

(73) Assignee: Sony Corporation, Tokyo (JP)

(21) Appl. No.: 14/632,205

(22) Filed: Feb. 26, 2015

(30) Foreign Application Priority Data
Mar. 5, 2014 (JP) 2014-042858

(51) Int. Cl. H04N 19/517; H04N 19/142

(52) U.S. Cl. CPC H04N 19/517; H04N 19/142

(57) ABSTRACT

An image processing apparatus includes a change information extraction unit that extracts image signal change information at positions at which an image signal of a moving picture stream changes suddenly, and an output unit that outputs a moving picture stream and image signal change information.

### CROSS REFERENCE TO RELATED APPLICATIONS

This application claims the benefit of Japanese Priority Patent Application JP 2014-042858 filed Mar. 5, 2014, the entire contents of which are incorporated herein by reference.

### BACKGROUND

The technology that is disclosed in the present specification relates to an image processing apparatus, an image processing method, and an image processing system that process high dynamic range moving pictures.

In recent years, an increase in the high dynamic range (HDR) of images has been progressing due to an increase in the bits of imaging elements (image sensors). In HDR images, a contrast ratio between a maximum lightness color and a minimum lightness color can, for example, reach 10000:1 or more, and realize the actual world in a realistic manner. In HDR images, there are advantages in that it is possible to realize shadows in a realistic manner, it is possible to simulate photographic exposure, and it is possible to realize glare.

For example, a suggestion of an imaging device that synthesizes HDR images from a plurality of captured images with different exposure amounts has been made (for example, refer to Japanese Unexamined Patent Application Publication No. 2013-255201).

Displays that correspond to HDR images in which the maximum brightness is approximately 500 nit or 1000 nit have begun to become commercially available. For example, HDR moving pictures are distributed through streaming from a server on the Internet, provided by setting recordable media such as a Blu-ray Disc as an intermediary, or broadcasted from a broadcasting station. A user can enjoy HDR moving pictures using an HDR-capable display.

### SUMMARY

It is desirable to provide an image processing apparatus, an image processing method, and an image processing system that can suitably process high dynamic range moving pictures.

According to an embodiment of the present technology, there is provided an image processing apparatus that includes a change information extraction unit that extracts image signal change information at positions at which an image signal of a moving picture stream changes suddenly, and an output unit that outputs a moving picture stream and image signal change information.

The image processing apparatus may further include an encoding unit that encodes a moving picture stream. Further, the output unit may output a moving picture stream after encoding by the encoding unit in addition to image signal change information.

In the image processing apparatus, the change information extraction unit may extract at least one of a color gamut when displaying a moving picture stream on a predetermined monitor, or a display brightness (cd/m²), a content brightness (%), or knee positional information during knee compression as image signal change information.

In the image processing apparatus, the output unit may send a moving picture stream and change information along a transmission path.

In the image processing apparatus, the change information extraction unit may extract change information from a moving picture stream in scene units, and the output unit may transmit an SEI of change information for each scene collectively at a head of a scene that corresponds to a moving picture stream.

In the image processing apparatus, the change information extraction unit may extract change information in which a value is gradually changed, and the output unit may transmit change information before and after positions at which an image signal of a moving picture stream changes suddenly, as metadata.

In the image processing apparatus, the change information extraction unit may extract change information that includes an amount of time or a frame number until a subsequent position at which an image signal changes suddenly, and an amount of change of an image signal at the position, and the output unit may transmit change information as an SEI or a TS descriptor of a moving picture stream, or metadata of an MP4 box.

In addition, according to another embodiment of the present technology, there is provided an image processing method that includes extracting image signal change information at positions at which an image signal of a moving picture stream changes suddenly, and outputting a moving picture stream and image signal change information.

In addition, according to still another embodiment of the present technology, there is provided an image processing apparatus that includes an input unit that inputs a moving picture stream in addition to image signal change information at positions at which an image signal changes suddenly, and a change information handling process unit that performs a handling process on an input moving picture stream on the basis of change information.

The image processing apparatus may further include a decoding unit that decodes a moving picture stream that is input by the input unit. Further, the change information handling process unit may perform a handling process on a moving picture stream after decoding by the decoding unit on the basis of change information.

In the image processing apparatus, the input unit may input change information at a position that is before the positions at which the image signal of the moving picture stream changes suddenly.

The image processing apparatus may further include a change information restoration unit that restores image signal change information from information that is input by the input unit.

In the image processing apparatus, the change information restoration unit may restore change information that is extracted in scene units of the moving picture stream and that is disposed at or associated with a head of the scene.

In the image processing apparatus, the change information restoration unit may restore change information from metadata that is disposed before and after positions at which an image signal changes suddenly, or associated therewith, by changing a value gradually.

In the image processing apparatus, the change information restoration unit may restore change information that includes an amount of time or a frame number until a subsequent position at which an image signal changes suddenly, and an amount of change of an image signal at the position from metadata of the moving picture stream.

In the image processing apparatus, the change information handling process unit may perform a process that suppresses sudden changes in an image signal of a moving picture stream on the basis of change information.

In addition, according to still another embodiment of the present technology, there is provided an image processing method including inputting a moving picture stream in addition to image signal change information at positions at which an image signal changes suddenly, and performing a handling process on an input moving picture stream on the basis of change information.

In addition, according to still another embodiment of the present technology, there is provided an image processing system including an image supply device that supplies a moving picture stream in addition to image signal change information at positions at which an image signal changes suddenly, and an image application device that performs a process that suppresses sudden changes in an image signal of a moving picture stream on the basis of the change information.

However, in this instance, “system” refers to an object in which a plurality of devices (or functional modules that realize specific functions) are logically accumulated, and whether or not each device or functional module is within a single housing is not taken into consideration.

According to the technology that is disclosed in the present specification, it is possible to provide a superior image processing apparatus and image processing method that can process HDR moving pictures in a manner in which it is possible to acquire image signal change information on a side of reception or reproduction.

In addition, according to the technology that is disclosed in the present specification, it is possible to provide a superior image processing apparatus and image processing method that can process HDR moving pictures in a manner that performs display that corresponds to sudden changes in an image signal by acquiring image signal change information in advance.

In addition, according to the technology that is disclosed in the present specification, it is possible to provide a superior image processing system that can perform a process that transmits or records HDR moving pictures to correspond with sudden changes in an image signal.

Additionally, the effects described in the present specification are merely examples, and the effects of the embodiments of the present technology are not limited thereto. In addition, there are also cases in which the embodiments of the present technology further exhibit additional effects other than those described above.

Other objects, features and advantages of the technology that is disclosed in the present technology will be elucidated using a detailed description that is based on the embodiments that are described below and the appended drawings.

### BRIEF DESCRIPTION OF THE DRAWINGS

FIG. 1 is a diagram that illustrates a circumstance in which an image signal changes in a temporal direction.

FIG. 2 is a diagram that schematically shows a configuration example of an image processing apparatus of an image supply source of an HDR moving picture.

FIG. 3 is a diagram that schematically shows a configuration example of an image processing apparatus of a reproduction side of an HDR moving picture.

FIG. 4 is a diagram that schematically shows an embodiment in which the technology that is disclosed in the present specification is applied to an image transmission system.

FIG. 5 is a diagram that schematically shows an embodiment in which the technology that is disclosed in the present specification is applied to an image recording and reproduction system.

FIG. 6 is a diagram that schematically shows an embodiment in which the technology that is disclosed in the present specification is applied to an image reception device.

### DETAILED DESCRIPTION OF EMBODIMENTS

Hereinafter, embodiments of the technology that is disclosed in the present specification will be described in detail while referring to the drawings.

Before describing the technology that is disclosed in the present specification, a description of SDR images and HDR images will be given.

HDR images have a dynamic range that is close to that of the real world, and for example, a contrast ratio between a maximum lightness color and a minimum lightness color reaches 10000:1 or more, for example. In HDR images, there are advantages in that it is possible to realize shadows in a realistic manner, it is possible to simulate photographic exposure, and it is possible to realize glare.

Meanwhile, if an image signal of brightness, color gamut or the like changes sharply in a temporal manner when displaying moving pictures on a display screen, there is a concern that there will be a health hazard for observers such as feeling bad.

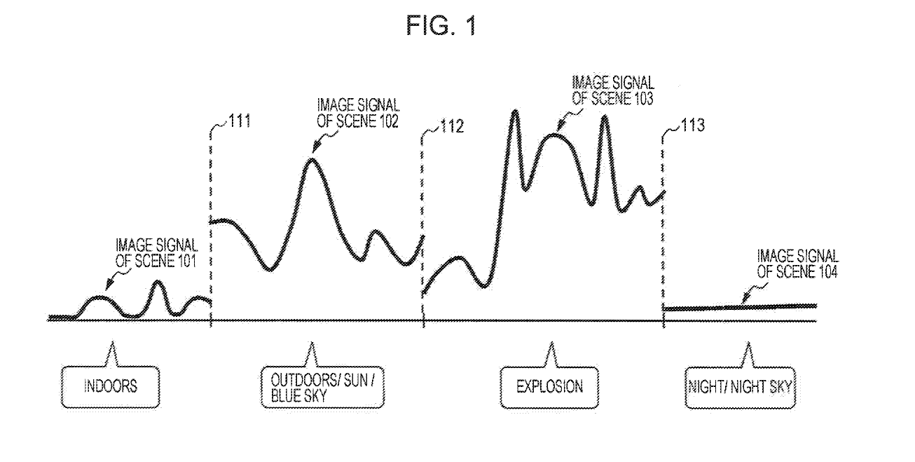

FIG. 1 illustrates a circumstance in which an image signal changes in a temporal direction. However, the horizontal axis is set as a temporal axis, and the vertical axis is set as a level of the image signal. The image signal is color gamut, brightness or the like.

In the example that is shown in FIG. 1, sudden changes in the image signal occur as a result of switching scenes. A scene 101 is a scene inside a room, a scene 102 is an outdoor scene which is captured in sunlight or beneath blue skies, a scene 103 is an explosion scene and a scene 104 is a scene at night or of a night sky. A single scene is, for example, configured by one or two or more Groups of Pictures (GOPs) in a moving picture stream in the MPEG (Moving Picture Experts Group) format.

An image signal such as color gamut or brightness changes suddenly at switches 111, 112 and 113 between each scene. Naturally, it is assumed that the image signal also changes suddenly within the scenes. In addition, it is also assumed that in addition to cases in which the image signal changes suddenly in an entire frame between scenes, sudden changes in an image signal occur in a portion of blocks or a portion of pixels within a frame. Further, in addition to the switches between scenes, there are also cases in which the image signal changes suddenly as a result of a frame changing to multiscreen, subtitles, an On Screen Display (OSD), or a menu being displayed within a frame or the like. In any case, when the image signal changes suddenly, the vision of an observer is stimulated to excess, and this brings about an effect on the health of the observer.

In particular, due to the fact that the dynamic range of HDR moving pictures is wide, the problem is more serious since the image signal changes significantly at the switches 111, 112 and 113 between each scene in FIG. 1.

In such an instance, in the technology that is disclosed in the present specification, an image processing apparatus of an image supply source of HDR moving pictures is set to extract image signal change information from source HDR moving pictures, and output the image signal change information in addition to HDR moving pictures. The image signal change information includes information such as positions at which an image signal changes suddenly and amounts of change and the like, and is output before positions at which an image signal changes suddenly. Meanwhile, an image processing apparatus on a reproduction side of HDR moving pictures is set so that an image signal does not change suddenly by applying a process to supplied HDR moving pictures on the basis of change information.

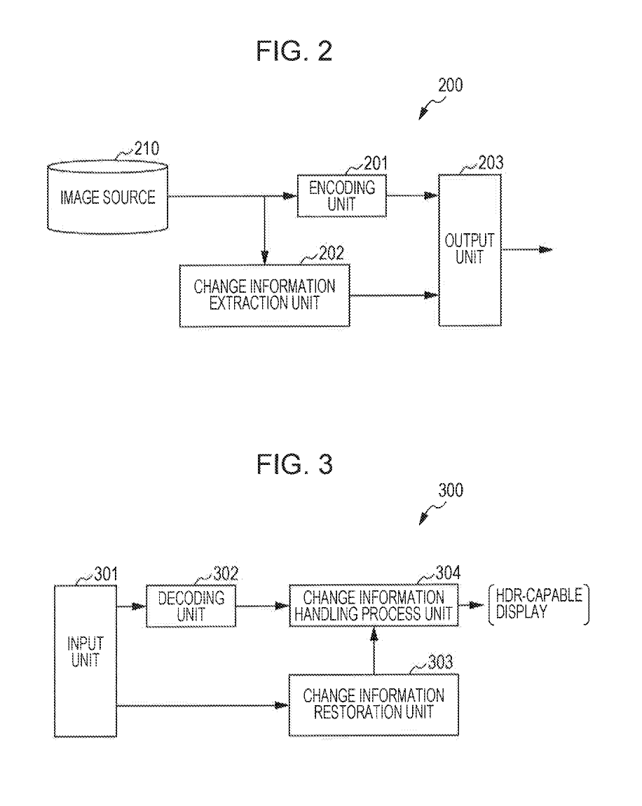

FIG. 2 schematically shows a configuration example of an image processing apparatus 200 of an image supply source of HDR moving pictures. The image processing apparatus 200 that is shown in the drawing is provided with an encoding unit 201, a change information extraction unit 202, and an output unit 203.

The encoding unit 201 inputs HDR moving pictures from an image source 210 as source images, and encodes the HDR moving pictures into a compressed format such as MPEG.

The change information extraction unit 202 extracts image signal change information from HDR moving pictures before the encoding unit 201 encodes the HDR moving pictures, and outputs the change information as metadata. The image signal change information includes positions at which an image signal changes suddenly, amounts of change and the like.

The output unit 203 outputs output information, which is formed from a moving picture stream after the encoding unit 201 has encoded HDR moving pictures, and change information that the change information extraction unit 202 has extracted, to the outside.

It is possible to include (1) to (4) below as image signal change information that the change information extraction unit 202 extracts from HDR moving pictures. In this instance, a master monitor is a display monitor that is used in the creation and editing of HDR images. In addition, a knee point is input knee positional information and output knee positional information when performing knee compression that suppresses a signal of high brightness portions so as to restrict the brightness of an image to a predetermined dynamic range. Items of image signal change information 121, 122, 123 and 124 for each scene 101, . . . are illustrated together in FIG. 1.

(1) Color gamut of master monitor
(2) Display brightness of master monitor (cd/m²)
(3) Brightness of content (%)
(4) Knee point

However, the items of image signal change information are merely examples, and it is possible to consider implementation through the extraction of only a portion of (1) to (4) as change information, the extraction of other change information in addition to (1) to (4), and the extraction of other change information instead of a portion of or all of (1) to (4).

It is possible to include a method that lists metadata according to an existing operational rule and a method that defines new data in order to list metadata as methods that output metadata that the change information extraction unit 202 has extracted.

As a method that follows an existing operational rule, for example, as shown below it is possible to list the abovementioned items of change information (1) to (4) as SEI (Supplemental Enhancement Information) which is already defined by an MPEG in the following manner.

(1) Color gamut of master monitor
Colour primaries info SEI (Mastering display info SEI)
(2) Display brightness of master monitor (cd/m²)
Tone mapping info SEI or Knee function info SEI
(3) Brightness of content (%)
Tone mapping info SEI of Knee function info SEI
(4) Knee point
Knee function info SEI

Alternatively, new data that lists changes (Up/Down flags or the like) and information (amounts of differences or an absolute values) that relates to amounts of change, is defined, and stores in an SEI, a TS descriptor or an MP4 box.

Material since a process that is based on change information is performed on supplied HDR moving pictures on a reproduction side of HDR moving pictures, as will be described later, it is necessary to output metadata so that change information will arrive on the reproduction side before HDR moving pictures.

In a case in which image signal change information is listed according to an existing rule, for example, the change information extraction unit 202 extracts each item of change information (1) to (4) in scene units. Further, the output unit 203 outputs by collecting each item of change information (1) to (4) and disposing the items of change information at a head of a scene of a moving picture stream, or associating the items of change information therewith.

Alternatively, the change information extraction unit 202 gradually changes a value of existing metadata that lists change information. Further, the output unit 203 outputs by sequentially disposing change information to match a reproduction position of a moving picture stream, or associating change information therewith. For example, values of metadata in which a brightness decreases gradually are output by being disposed before and after switching points of original scenes (or positions at which an image signal changes suddenly) in the manner of a Fade In/Out, or associated therewith.

In addition, new data is defined, and notification of image signal change information is performed in advance. For example, if the change information extraction unit 202 detects that an image signal changes suddenly after XX seconds (or after XX frames) of a moving picture stream, positional information at which an image signal changes suddenly (after XX seconds or after XX frames), information that indicates the presence or absence of changes (Up/Down flags or the like), and information that relates to amounts of change (amounts of differences or absolute values) are output as the change information. Further, the output unit 203 transmits the change information using an SEI, a TS descriptor, an MP4 box or the like.

FIG. 3 schematically shows a configuration example of an image processing apparatus 300 of a reproduction side of an HDR moving picture. The image processing apparatus 300 that is shown in the drawing is provided with an input unit 301, a decoding unit 302, a change information restoration unit 303 and a change information handling process unit 304.

The input unit 301 inputs output information that is output from the image processing apparatus 200 of the image supply source of HDR moving pictures. The output information from the image processing apparatus 200 includes an encoded moving picture stream, and image signal change information. The change information is stored in the output information in a manner in which it is possible to obtain the change information before positions in the moving picture stream at which an image signal changes suddenly. For example, an SEI of each item of change information that is extracted for each scene is included output information by collecting the SEI of each item of change information and disposing the SEI of each item of change information at a head of a scene, or associating the SEI of each item of change information therewith (as mentioned above). The input unit 301 separates a moving picture stream and change information from input output information.

The decoding unit 302 decodes a moving picture stream that is encoded into a compressed format such as MPEG, and outputs to the change information handling process unit 304. A moving picture stream is transmitted from the decoding unit 302 to the change information handling process unit 304 using an interface such as HDMI (High Definition Multimedia Interface; Registered Trademark), for example.

The change information restoration unit 303 restores change information that is included in output information input by the input unit 301, and outputs to the change information handling process unit 304.

For example, the change information restoration unit 303 restores change information that is extracted in scene units of a moving picture stream, and disposed at a head of a scene, or associated therewith.

Alternatively, the change information restoration unit 303 restores change information from metadata that is disposed before and after positions at which an image signal changes suddenly or associated therewith by changing a value thereof gradually.

Alternatively, the change information restoration unit 303 restores change information in which positional information at which an image signal changes suddenly (after XX seconds or after XX frames), information that indicates the presence or absence of changes (Up/Down flags or the like), and information that relates to amounts of change (amounts of differences or an absolute values) are registered from metadata that is transmitted using an SEI, a TS descriptor, an MP4 box or the like.

The change information handling process unit 304 can acquire change information from the change information restoration unit 303 before positions in a moving picture stream at which an image signal changes suddenly. Further, when a moving picture stream that is input from the decoding unit 302 reaches positions at which an image signal changes suddenly, the change information handling process unit 304 performs a process that moderates sudden changes in an image signal on the basis of change information that is acquired in advance.

For example, the change information handling process unit 304 removes, or suppresses a high frequency component by passing image signals of positions at which an image signal changes suddenly through a low pass filter. Additionally, the change information handling process unit 304 performs a handling process on an entire frame in which an image signal changes suddenly, blocks within a frame in which an image signal changes suddenly, or pixels within a frame in which an image signal changes suddenly.

A moving picture stream that has been processed by the change information handling process unit 304 is displayed on an HDR-capable display such as a liquid crystal display panel (not shown in the drawings). Since sudden changes in an image signal are suppressed in HDR moving pictures that are displayed using an HDR-capable display, it is possible to prevent health hazards for observers such as feeling bad.

### Embodiment 1

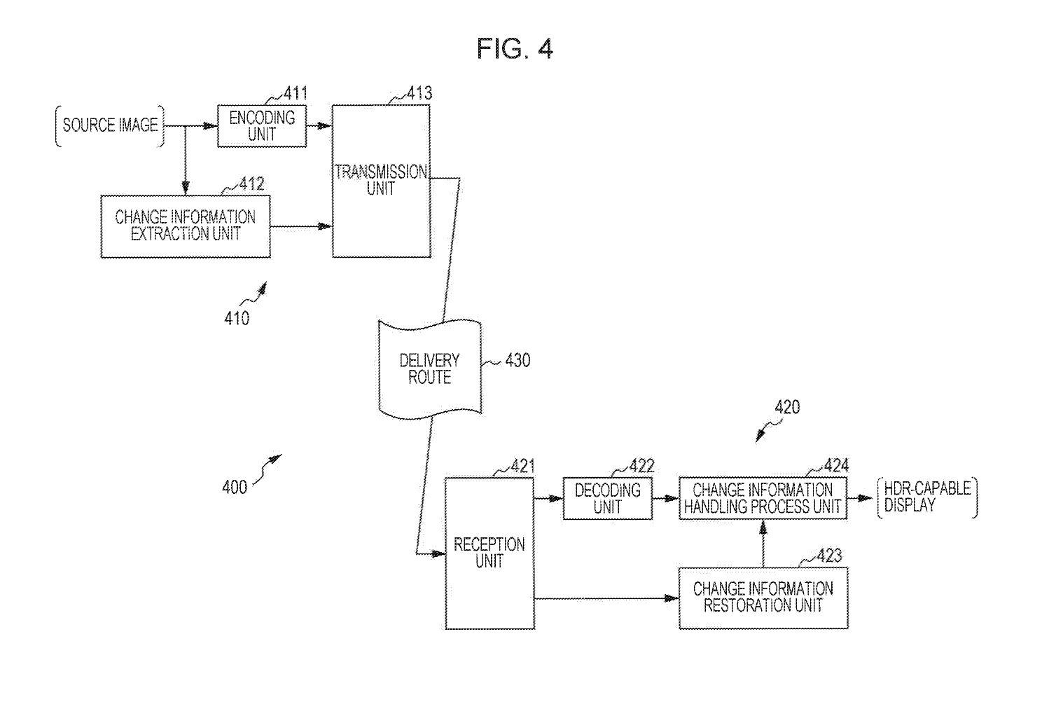

FIG. 4 schematically shows an embodiment in which the technology that is disclosed in the present specification is applied to an image transmission system 400. The image transmission system 400 that is shown in the drawing is configured by an image transmission device 410 and an image reception device 420, and the transmission of moving picture streams is performed via a transmission path 430.

For example, the image transmission device 410 is a digital broadcast broadcasting station of a terrestrial or satellite waves, and the image reception device 420 is a Set Top Box (STB), a tuner, a digital TV or the like that tunes and receives a digital broadcasting signal. The transmission path 430 is the air through which a broadcasting signal is conveyed. In addition, the image transmission device 410 is, for example, managed by a broadcasting organization that broadcasts HDR program content.

Alternatively, the image transmission device 410 is a distribution server that distributes moving picture streams through streaming, and the image reception device 420 is an item of information equipment such as a personal computer for receiving and viewing moving picture streams. The transmission path 430 in this case is a TCP/IP network such as the Internet. In addition, the image transmission device 410 is managed by a content provider that distributes HDR moving pictures through streaming on a network such as the Internet.

The image transmission device 410 is provided with an encoding unit 411, a change information extraction unit 412 and a transmission unit 413.

The encoding unit 411 inputs HDR moving pictures from an image source such as a master monitor (not shown in the drawings) as source images, and encodes the HDR moving pictures into a compressed format such as MPEG.

The change information extraction unit 412 extracts image signal change information from HDR moving pictures before the encoding unit 411 encodes the HDR moving pictures, and outputs the change information as metadata. The image signal change information includes positions at which an image signal changes suddenly, amounts of change and the like. Specific examples of change information are as already described earlier.

The transmission unit 413 sends transmission information such as moving picture streams after encoding and metadata that includes image signal change information along the transmission path 430 through packetization thereof.

In a case in which a process that corresponds to changes in an image signal is performed on a side of the image reception device 420, it is necessary for corresponding metadata to arrive at the image reception device 420 before positions in a moving picture stream at which an image signal changes suddenly.

For example, the change information extraction unit 412 extracts each item of change information in scene units. Further, the transmission unit 413 is set to dispatch an SEI of each item of change information collectively at a head of a scene that corresponds to a moving picture stream.

Alternatively, the change information extraction unit 412 extracts change information in which a value is gradually changed. Further, the transmission unit 413 transmits change information before and after positions at which an image signal in a moving picture stream changes suddenly as metadata. For example, the transmission unit 413 transmits values of metadata in which a brightness decreases gradually using an SET, a TS descriptor, or an MP4 box before and after switching points of original scenes in the manner of a Fade In/Out.

Alternatively, the change information extraction unit 412 detects that an image signal changes suddenly after XX seconds (or after XX frames) of a moving picture stream, and outputs positional information at which an image signal changes (after XX seconds or after XX frames), information that indicates the presence or absence of changes (Up/Down flags or the like), and information that relates to amounts of change (amounts of differences or absolute values) as the change information. Further, the transmission unit 413 transmits the change information in advance using an SEI, a TS descriptor, an MP4 box or the like.

The image reception device 420 is provided with a reception unit 421, a decoding unit 422, a change information restoration unit 423 and a change information handling process unit 424.

The reception unit 421 receives packets that are transmitted from the image transmission device 410, and assembles a source moving picture stream through alignment of the packets.

The decoding unit 422 decodes a moving picture stream that is encoded into a compressed format such as MPEG, and outputs the stream to the change information handling process unit 424. A moving picture stream is transmitted from the decoding unit 422 to the change information handling process unit 424 using an interface such as HDMI (Registered Trademark), for example.

The change information restoration unit 423 retrieves and restores change information that is stored in an SEI, a TS descriptor, an MP4 box or the like of a received moving picture stream, and outputs the information to the change information handling process unit 424. The change information is transmitted before positions in a moving picture stream at which an image signal changes suddenly so that it is possible to perform a process that corresponds to changes in an image signal in the change information handling process unit 424.

The change information handling process unit 424 acquires change information from the change information restoration unit 423 before positions in a moving picture stream at which an image signal changes suddenly. Further, when a moving picture stream that is input from the decoding unit 422 reaches positions at which an image signal changes suddenly, the change information handling process unit 424 performs a process that moderates sudden changes in an image signal on the basis of change information that is acquired in advance. For example, the change information handling process unit 424 removes, or suppresses a high frequency component by passing image signals of positions at which an image signal changes suddenly through a low pass filter.

A moving picture stream that has been processed by the change information handling process unit 424 is displayed on an HDR-capable display such as a liquid crystal display panel (not shown in the drawings). Since sudden changes in an image signal are suppressed in HDR moving pictures that are displayed using an HDR-capable display, it is possible to prevent health hazards for observers such as feeling bad.

### Embodiment 2

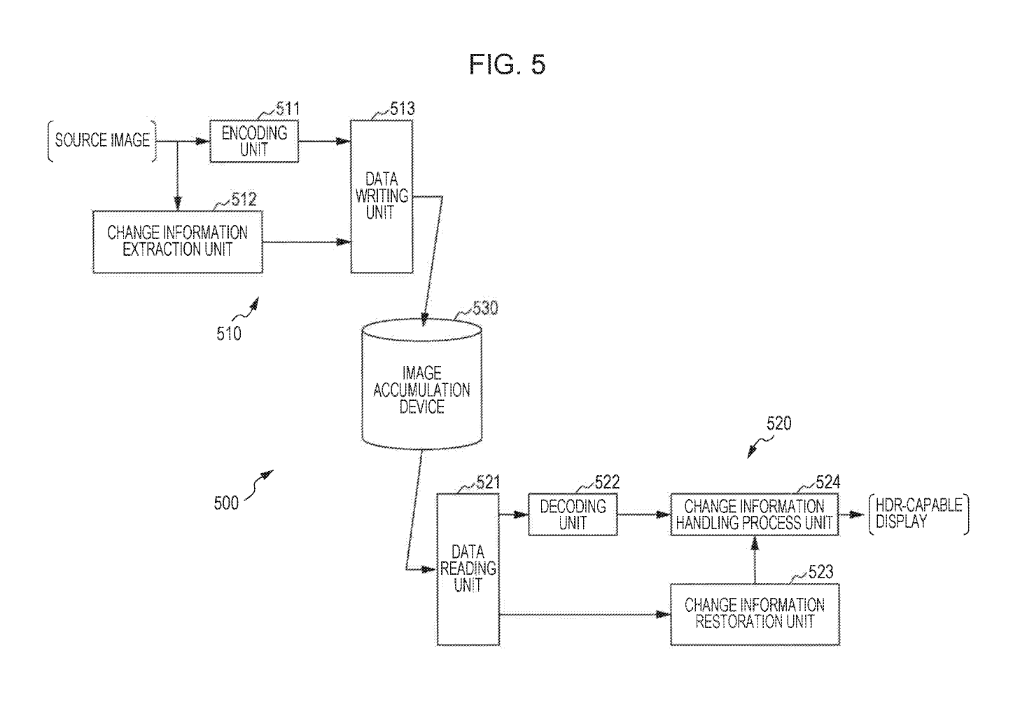

FIG. 5 schematically shows an embodiment in which the technology that is disclosed in the present specification is applied to an image recording and reproduction system 500. The image recording and reproduction system 500 that is shown in the drawing is configured by an image recording device 510 that records moving picture streams on an image accumulation device 530, and an image reproduction device 520 that reproduces moving picture streams that are recorded on the image accumulation device 530. The image accumulation device 530 is a media recording and reproduction device that performs the writing and reading of data on a large capacity recording device such as a hard disk drive, or a portable recording medium such as a Blu-ray Disc. The image recording device 510 is, for example, managed by a media sales company that sells recorded media such as Blu-ray Discs on which HDR moving pictures are recorded.

The image recording device 510 is provided with an encoding unit 511, a change information extraction unit 512 and a data writing unit 513.

The encoding unit 511 inputs HDR moving pictures as source images, and encodes the HDR moving pictures into a compressed format such as MPEG.

The change information extraction unit 512 extracts image signal change information from HDR moving pictures before the encoding unit 511 encodes the HDR moving pictures, and outputs the change information as metadata. The image signal change information includes positions at which an image signal changes suddenly, amounts of change and the like. Specific examples of change information are as already described earlier.

The data writing unit 513 writes recording information such as moving picture streams after encoding and metadata that includes image signal change information to the image accumulation device 530 according to a predetermined file system such as FAT (File Allocation Table), for example.

In a case in which a process that corresponds to changes in an image signal is performed on a side of the image reproduction device 520, it is necessary for the image reproduction device 520 to be able to acquire corresponding metadata before positions in a moving picture stream at which an image signal changes suddenly.

For example, the change information extraction unit 512 extracts each item of change information in scene units. Further, the data writing unit 513 is set to record each item of change information on the image accumulation device 530 by collectively disposing each item of change information at a head of a scene that corresponds to a moving picture stream. Alternatively, the data writing unit 513 is set to record each item of change information that is extracted in scene units on the image accumulation device 530 as a separate file from a moving picture stream by setting such that a correspondence relationship with a head position of a corresponding scene is understood.

Alternatively, the change information extraction unit 512 gradually changes a value of metadata that lists change information. Further, the data writing unit 513 records metadata on the image accumulation device 530 to match a reproduction position of a moving picture stream. For example, values of metadata in which a brightness decreases gradually are recorded before and after switching points of original scenes in the manner of a Fade In/Out.

Alternatively, the change information extraction unit 512 detects that an image signal changes suddenly after XX seconds (or after XX frames) of a moving picture stream, and outputs positional information at which an image signal changes (after XX seconds or after XX frames), information that indicates the presence or absence of changes (Up/Down flags or the like), and information that relates to amounts of change (amounts of differences or absolute values) as the change information. Further, the data writing unit 513 records the change information on the image accumulation device 530 by disposing the change information in a position in a moving picture stream that is XX seconds before or XX frames before.

The image reproduction device 520 is provided with a data reading unit 521, a decoding unit 522, a change information restoration unit 523 and a change information handling process unit 524.

The data reading unit 521 reads a moving picture stream and metadata from the image accumulation device 530.

The decoding unit 522 decodes a moving picture stream that is encoded into a compressed format such as MPEG, and outputs the stream to the change information handling process unit 524. A moving picture stream is transmitted from the decoding unit 522 to the change information handling process unit 524 using an interface such as HDMI (Registered Trademark), for example.

The change information restoration unit 523 restores change information from metadata that the data reading unit 521 reads from the image accumulation device 530, and outputs the information to the change information handling process unit 524.

The change information restoration unit 523 restores corresponding change information before positions in a moving picture stream at which an image signal changes suddenly so that it is possible to perform a process that corresponds to changes in an image signal in the change information handling process unit 524.

For example, metadata of change information is disposed at a head of a scene that corresponds to a moving picture stream. Alternatively, change information is recorded on the image accumulation device 530 as a separate file from a moving picture stream by setting such that a correspondence relationship with a head position of a corresponding scene is understood.

Alternatively, metadata of change information in which a value is gradually changed is recorded on the image accumulation device 530 to match a reproduction position of a moving picture stream. For example, values of metadata in which a brightness decreases gradually are recorded before and after switching points of original scenes in the manner of a Fade In/Out.

Alternatively, metadata of change information that includes positional information at which an image signal changes (after XX seconds or after XX frames), information that indicates the presence or absence of changes (Up/Down flags or the like), and information that relates to amounts of change (amounts of differences or absolute values) is recorded on the image accumulation device 530 by being disposed in a moving picture stream XX seconds before (or XX frames before) an image signal changes suddenly of a moving picture stream.

The change information handling process unit 524 acquires change information from the change information restoration unit 523 before positions in a moving picture stream at which an image signal changes suddenly. Further, when a moving picture stream that is input from the decoding unit 522 reaches positions at which an image signal changes suddenly, the change information handling process unit 524 performs a process that moderates sudden changes in an image signal on the basis of change information that is acquired in advance. For example, the change information handling process unit 524 removes, or suppresses a high frequency component by passing image signals of positions which change suddenly through a low pass filter.

A moving picture stream that has been processed by the change information handling process unit 524 is displayed on an HDR-capable display such as a liquid crystal display panel (not shown in the drawings). Since sudden changes in an image signal are suppressed in HDR moving pictures that are displayed using an HDR-capable display, it is possible to prevent health hazards for observers such as feeling bad.

### Embodiment 3

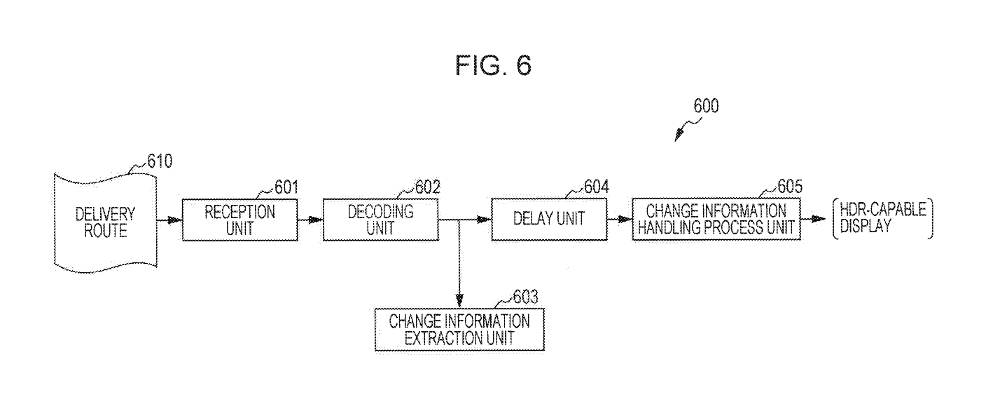

FIG. 6 schematically shows an embodiment in which the technology that is disclosed in the present specification is applied to an image reception device 600. The image reception device 600 receives an HDR moving picture stream that is broadcast from a broadcasting station, or distributed from a distribution server on the Internet.

The image reception device 600 that is shown in the drawing is provided with a reception unit 601, a decoding unit 602, a change information extraction unit 603, a delay unit 604, and a change information handling process unit 605.

The reception unit 601 receives packets from a transmission path 610, and assembles a source moving picture stream through alignment of the packets. In addition, the decoding unit 602 decodes a moving picture stream that is encoded into a compressed format such as MPEG.

The change information extraction unit 603 extracts image signal change information from HDR moving pictures after decoding by a decoding unit, and outputs the change information to the change information handling process unit 605. The image signal change information includes positions at which an image signal changes suddenly, amounts of change and the like. Specific examples of change information are as already described earlier.

For example, the change information extraction unit 603 extracts image signal change information in scene units. The delay unit 604 delays inputting a moving picture stream that the decoding unit 602 decodes to the change information handling process unit 605 until the change information extraction unit 603 has extracted scene change information, and it is possible to perform a process on the corresponding scenes.

The change information handling process unit 605 performs a process that moderates sudden changes in an image signal on a moving picture stream on the basis of change information that is supplied from the change information extraction unit 603. For example, the change information handling process unit 605 removes, or suppresses a high frequency component by passing image signals of positions at which an image signal changes suddenly through a low pass filter.

A moving picture stream that has been processed by the change information handling process unit 605 is displayed on an EDR-capable display such as a liquid crystal display panel (not shown in the drawings). Since sudden changes in an image signal are suppressed in HDR moving pictures that are displayed using an HDR-capable display, it is possible to prevent health hazards for observers such as feeling bad.

Additionally, it is possible for the technology of the technology of the present specification to have configurations such as those below.

(1) An image processing apparatus including a change information extraction unit that extracts image signal change information at positions at which an image signal of a moving picture stream changes suddenly, and an output unit that outputs a moving picture stream and image signal change information.

(2) The image processing apparatus according to (1), further including an encoding unit that encodes a moving picture stream, in which the output unit outputs a moving picture stream after encoding by the encoding unit in addition to image signal change information.

(3) The image processing apparatus according to (1), in which the change information extraction unit extracts at least one of a color gamut when displaying a moving picture stream on a predetermined monitor, or a display brightness (cd/m²), a content brightness (%), or knee positional information during knee compression as image signal change information.

(4) The image processing apparatus according to (1), in which the output unit outputs change information at a position that is before the positions at which the image signal of the moving picture stream changes suddenly.

(5) The image processing apparatus according to (4), in which the change information extraction unit extracts image signal change information of a moving picture stream in scene units, and the output unit outputs change information of each scene by disposing change information at a head of a scene of a moving picture stream or associating change information with a head of a scene.

(6) The image processing apparatus according to (4), in which the change information extraction unit extracts change information in which a value is gradually changed, and the output unit outputs by disposing change information before and after positions at which an image signal of a moving picture stream changes suddenly, or associating change information therewith.

(7) The image processing apparatus according to (4), in which the change information extraction unit extracts change information that includes an amount of time or a frame number until a subsequent position at which an image signal changes suddenly, and an amount of change of an image signal at the position, and the output unit outputs change information as metadata of a moving picture stream.

(8) The image processing apparatus according to (1), in which the output unit sends a moving picture stream and change information along a transmission path.

(9) The image processing apparatus according to (8), in which the change information extraction unit extracts change information from a moving picture stream in scene units, and the output unit transmits an SEI of change information for each scene collectively at a head of a scene that corresponds to a moving picture stream.

(10) The image processing apparatus according to (8), in which the change information extraction unit extracts change information in which a value is gradually changed, and the output unit transmits change information before and after positions at which an image signal of a moving picture stream changes suddenly, as metadata.

(11) The image processing apparatus according to (8), in which the change information extraction unit extracts change information that includes an amount of time or a frame number until a subsequent position at which an image signal changes suddenly, and an amount of change of an image signal at the position, and the output unit transmits change information as an SEI or a TS descriptor of a moving picture stream, or metadata of an MP4 box or the like.

(12) An image processing method including extracting image signal change information at positions at which an image signal of a moving picture stream changes suddenly, and outputting a moving picture stream and image signal change information.

(13) An image processing apparatus including an input unit that inputs a moving picture stream in addition to image signal change information at positions at which an image signal changes suddenly, and a change information handling process unit that performs a handling process on an input moving picture stream on the basis of change information.

(14) The image processing apparatus according to (13), further including a decoding unit that decodes a moving picture stream that is input by the input unit, in which the change information handling process unit performs a handling process on a moving picture stream after decoding by the decoding unit on the basis of change information.

(15) The image processing apparatus according to (13), in which the input unit inputs change information at a position that is before the positions at which the image signal of the moving picture stream changes suddenly.

(16) The image processing apparatus according to (13), further including a change information restoration unit that restores image signal change information from information that is input by the input unit.

(17) The image processing apparatus according to (16), in which the change information restoration unit restores change information that is extracted in scene units of the moving picture stream and that is disposed at or associated with a head of the scene.

(18) The image processing apparatus according to (16), in which the change information restoration unit restores change information from metadata that is disposed before and after positions at which an image signal changes suddenly, or associated therewith, by changing a value gradually.

(19) The image processing apparatus according to (16), in which the change information restoration unit restores change information that includes an amount of time or a frame number until a subsequent position at which an image signal changes suddenly, and an amount of change of an image signal at the position from metadata of the moving picture stream.

(20) The image processing apparatus according to (13), in which the change information handling process unit performs a process that suppresses sudden changes in an image signal of a moving picture stream on the basis of the change information.

(21) An image processing method including inputting a moving picture stream in addition to image signal change information at positions at which an image signal changes suddenly, and performing a handling process on an input moving picture stream on the basis of change information.

(22) An image processing system including an image supply device that supplies a moving picture stream in addition to image signal change information at positions at which an image signal changes suddenly, and an image application device that performs a process that suppresses sudden changes in an image signal of a moving picture stream on the basis of the change information.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a change information extraction unit that extracts image signal change information at positions at which an image signal of a moving picture stream changes suddenly; and
an output unit that outputs a moving picture stream and image signal change information.

2. The image processing apparatus according to claim 1, further comprising:
an encoding unit that encodes a moving picture stream,
wherein the output unit outputs a moving picture stream after encoding by the encoding unit in addition to image signal change information.

3. The image processing apparatus according to claim 1,
wherein the change information extraction unit extracts at least one of a color gamut when displaying a moving picture stream on a predetermined monitor, or a display brightness (cd/m²), a content brightness (%), or knee positional information during knee compression as image signal change information.

4. The image processing apparatus according to claim 1,
wherein the output unit sends a moving picture stream and change information along a transmission path.

5. The image processing apparatus according to claim 4,
wherein the change information extraction unit extracts change information from a moving picture stream in scene units, and
wherein the output unit transmits an SEI of change information for each scene collectively at a head of a scene that corresponds to a moving picture stream.

6. The image processing apparatus according to claim 4,
wherein the change information extraction unit extracts change information in which a value is gradually changed, and
wherein the output unit transmits change information before and after positions at which an image signal of a moving picture stream changes suddenly, as metadata.

7. The image processing apparatus according to claim 4,
wherein the change information extraction unit extracts change information that includes an amount of time or a frame number until a subsequent position at which an image signal changes suddenly, and an amount of change of an image signal at the position, and
wherein the output unit transmits change information as an SEI or a TS descriptor of a moving picture stream, or metadata of an MP4 box.

8. An image processing method comprising:
extracting image signal change information at positions at which an image signal of a moving picture stream changes suddenly; and
outputting a moving picture stream and image signal change information.

9. An image processing apparatus comprising:
an input unit that inputs a moving picture stream in addition to image signal change information at positions at which an image signal changes suddenly; and
a change information handling process unit that performs a handling process on an input moving picture stream on the basis of change information.

10. The image processing apparatus according to claim 9, further comprising:
a decoding unit that decodes a moving picture stream that is input by the input unit,
wherein the change information handling process unit performs a handling process on a moving picture stream after decoding by the decoding unit on the basis of change information.

11. The image processing apparatus according to claim 9,
wherein the input unit inputs change information at a position that is before the positions at which the image signal of the moving picture stream changes suddenly.

12. The image processing apparatus according to claim 9, further comprising:
a change information restoration unit that restores image signal change information from information that is input by the input unit.

13. The image processing apparatus according to claim 12,
wherein the change information restoration unit restores change information that is extracted in scene units of the moving picture stream and that is disposed at or associated with a head of the scene.

14. The image processing apparatus according to claim 12,
wherein the change information restoration unit restores change information from metadata that is disposed before and after positions at which an image signal changes suddenly, or associated therewith, by changing a value gradually.

15. The image processing apparatus according to claim 12,
wherein the change information restoration unit restores change information that includes an amount of time or a frame number until a subsequent position at which an image signal changes suddenly, and an amount of change of an image signal at the position from metadata of the moving picture stream.

16. The image processing apparatus according to claim 9,
wherein the change information handling process unit performs a process that suppresses sudden changes in an image signal of a moving picture stream on the basis of the change information.

17. An image processing method comprising:
inputting a moving picture stream in addition to image signal change information at positions at which an image signal changes suddenly; and
performing a handling process on an input moving picture stream on the basis of change information.

18. An image processing system comprising:
an image supply device that supplies a moving picture stream in addition to image signal change information at positions at which an image signal changes suddenly; and
an image application device that performs a process that suppresses sudden changes in an image signal of a moving picture stream on the basis of the change information.
